(19) United States
(12) Patent Application Publication
(10) Pub. No.: US 2022/0241800 A1
(43) Pub. Date: Aug. 4, 2022

(54) Temperature control for a centrifuge

(71) Applicant: Eppendorf AG, Hamburg (DE)

(72) Inventor: Danilo DRÖSE, Leipzig (DE)

(73) Assignee: Eppendorf AG, Hamburg (DE)

(21) Appl. No.: 17/603,744

(22) PCT Filed: Mar. 16, 2020
(86) PCT No.: PCT/EP2020/057123

§ 371 Date: Oct. 14, 2021

(30) Foreign Application Priority Data
Apr. 16, 2019 (EP) 19169446.2

(51) Int. Cl. B04B 15/02; B04B 7/02; B04B 13/00

(52) U.S. Cl. CPC B04B 15/02; B04B 13/00; B04B 7/02

(57) ABSTRACT

A centrifuge, in particular as a laboratory centrifuge, has a centrifuge container in which a centrifuge rotor can be accommodated, a centrifuge motor for driving the centrifuge rotor, and a housing with a base and lateral side walls. The centrifuge container, the centrifuge rotor and the centrifuge motor are accommodated in the housing. A temperature control device for controlling the temperature of the centrifuge rotor has air directing means which are adapted to suck in air into the centrifuge container in a lower region. Such temperature control of the centrifuge operates more effectively than before. At the same time, the cooling of heat-emitting centrifuge components, such as the centrifuge motor and electronic components, takes place. The temperature control also functions if a safety container is arranged around the centrifuge container.

### CROSS-REFERENCE TO RELATED APPLICATION

This application is a national stage application, filed under 35 U.S.C. § 371, of International Patent Application No. PCT/EP2020/057123, filed on 2020 Mar. 16, which claims the benefit of European Patent Application No. 19169446.2, filed 2019 Apr. 16.

### TECHNICAL FIELD

The present disclosure relates to a centrifuge with temperature control and to a method for controlling the temperature of a centrifuge.

### BACKGROUND

Centrifuges, in particular laboratory centrifuges, are used to separate the components of samples centrifuged therein by utilizing mass inertia. Increasingly higher rotation speeds are used to achieve high segregation rates. Laboratory centrifuges are centrifuges whose centrifuge rotors operate at preferentially at least 3,000, preferably at least 10,000, in particular at least 15,000 revolutions per minute, and are usually placed on tables. In order to be able to place them on a worktable, they have a form factor of less than 1 m×1 m×1 m in particular, so their installation space is limited. In doing so, the device depth is preferably limited to max. 70 cm.

The samples to be centrifuged are stored in sample containers and such sample containers are driven in rotation by means of a centrifuge rotor. Typically, there are fixed-angle rotors and swing-out rotors, which are used depending on the application. In doing so, the sample containers may contain the samples directly, or separate sample receptacles are inserted into the sample containers that contain the sample, such that a large number of samples can be centrifuged simultaneously in one sample container.

In most cases, it is provided that the samples are centrifuged at specific temperatures. For example, samples containing proteins and similar organic substances must not be overheated, such that the upper limit for controlling the temperature of such samples is in the range of 40° C. by default. On the other hand, certain samples are cooled by default in the +4° C. range (the anomaly of water starts at 3.98° C.).

In addition to such predetermined maximum temperatures of, for example, approximately +40° C. and standard test temperatures such as 4° C., other standard test temperatures are also provided, such as at 11° C., in order to test at such temperature whether the refrigeration system of the centrifuge is running in a controlled manner below room temperature. On the other hand, for occupational safety reasons, it is necessary to prevent the touching of elements that have a temperature of greater than or equal to 60° C. Comparative values are given in DIN EN 61010-1:2011-07, Table 19.

In principle, active and passive systems can be used for temperature control. Active cooling systems have a refrigerant circuit that controls the temperature of the centrifuge container (centrifuge vessel), by which the centrifuge rotor and the sample containers accommodated therein are indirectly cooled.

Passive systems are based on exhaust-assisted cooling or ventilation, as the case may be. This air is fed directly past the centrifuge rotor and thus also past the sample containers accommodated therein, resulting in temperature control. The air is fed into the centrifuge container from above, wherein the suction is performed independently by the rotation of the centrifuge rotor.

The disadvantage of this passive temperature control is that it is not highly effective.

Furthermore, the cooling of centrifuge components is necessary to prevent the heat generated there from radiating to the samples. This requires additional cooling devices.

### SUMMARY

It is an object of the present disclosure to provide a laboratory centrifuge with a temperature control system that operates more effectively than known systems. In particular, this temperature control should also allow the centrifuge components to be cooled at the same time. Preferably, the temperature control should also function in the presence of a safety container (safety vessel, shell vessel) around the centrifuge container.

Whenever the present disclosure refers to “temperature control of the centrifuge rotor,” this always includes temperature control of the material accommodated in the centrifuge rotor, i.e. in particular sample containers and samples accommodated therein. Moreover, “temperature control” means not only cooling, but also heating.

This object is achieved with the centrifuge and the method as claimed. Advantageous additional forms are disclosed in the following description, also in connection with the figures.

The inventors have realized that this object can be achieved particularly easily and efficiently by sucking air into the centrifuge container in a lower region of the centrifuge container.

As a result, air now enters the centrifuge container below the centrifuge rotor. This increases the cooling effect, because a natural air flow is now supported by the fact that cool air enters the centrifuge container at the bottom and, after being heated by the centrifuge rotor, can exit the centrifuge container at a warm temperature.

The centrifuge, in particular a laboratory centrifuge, includes a centrifuge container in which a centrifuge rotor can be accommodated. It further includes a centrifuge motor for driving the centrifuge rotor, and a housing with a base and lateral side walls. The centrifuge container, the centrifuge rotor and the centrifuge motor, and a temperature control device for controlling the temperature of the centrifuge rotor, are accommodated in the housing. The temperature control device comprises air directing means, which are adapted to suck air into the centrifuge container in a lower region of the centrifuge container. This suction is preferably effected by the rotation of the centrifuge rotor; separate ventilation means could alternatively or additionally also be used.

In an advantageous embodiment, such air directing means have one or more openings in the base region of the centrifuge container. This makes the centrifuge particularly simple in structure.

In an advantageous additional embodiment, the air directing means are configured to suck in supply air through the base and/or at least one side wall of the centrifuge housing, wherein such supply air is preferentially directed directly from the centrifuge housing to the centrifuge container, without coming into contact with heat-emitting elements of the centrifuge, in particular the centrifuge motor and/or electronic components of the centrifuge. As a result, very short air flow paths are realized before the air enters the centrifuge container, and cooling performance is improved, because no heating of the supply air by centrifuge heat-emitting components can occur. In this context, side walls are not only laterally arranged walls, but also the front side and back side of the housing.

In an advantageous additional embodiment, the air directing means are configured to guide exhaust air from the centrifuge container past the centrifuge motor and/or past electronic components of the centrifuge. The exhaust air is preferentially guided first past the centrifuge motor and then past the electronic components. As a result, in addition to temperature control of the centrifuge container, the cooling of the other centrifuge components can also take place at the same time, further improving the temperature control performance.

In an advantageous additional embodiment, the air directing means are configured to discharge exhaust air from the centrifuge container out of the centrifuge housing in such a way that the re-entry of the exhaust air into the centrifuge container is prevented. This makes the cooling of the centrifuge container particularly effective. Preferably, such discharge of the exhaust air from the centrifuge housing takes place after the exhaust air has passed the centrifuge motor and/or electrical components of the centrifuge for cooling, because the cooling effect of the supply air can then be used particularly efficiently.

In an advantageous additional embodiment, the air directing means are configured to guide exhaust air from the centrifuge container along the outer side of the centrifuge container. Preferentially, guidance thereby takes place in the direction of the base of the centrifuge housing. This makes the utilization of the cooling effect of the supply air particularly effective.

In an advantageous additional embodiment, the centrifuge further comprises a safety container that at least partially encloses the centrifuge container. The air directing means are preferentially configured to guide exhaust air from the centrifuge container between the centrifuge container and the safety container. As a result, the centrifuge meets the highest safety standards and yet the temperature control is highly efficient, while the cooling device is kept highly compact.

In an advantageous additional embodiment, the safety container has one or more openings for the supply air in its base region. In this case, the air guide is particularly short and, moreover, this design does not reduce safety, because the centrifuge motor is usually located in the base region of the safety container, which provides an energy absorption capability in the event of a crash (shattering of the centrifuge rotor in accordance with DIN EN 61010-2-020:2017-12).

In an advantageous additional embodiment, the air directing means are embodied to be thermally insulated at least in some regions and/or the centrifuge container is provided with thermal insulation on its outer side in the region of the air guide. Then the temperature control is particularly efficient, wherein thermal bridges and thermal short circuits are avoided.

In an advantageous additional embodiment, the air directing means are embodied as one or more molded parts, in particular foam molded parts, preferentially made of polypropylene or polyurethane. The air directing means can then be produced particularly easily and cost-effectively.

In an advantageous additional embodiment, at least one sound-insulating foam element, preferentially made of polyurethane, is used for sound insulation. Noise caused by the air guide can then be effectively dampened towards a user.

In an advantageous additional embodiment, the air directing means are embodied in several parts, preferentially consisting of a lower part for supplying the supply air to the centrifuge container and for discharging the exhaust air to the centrifuge motor and/or to electronic components, and an upper part for discharging the exhaust air from the centrifuge container into the space between the centrifuge container and the safety container. The centrifuge is then particularly easy to assemble.

Within the framework of this description, “electronic components” also refers to electrical components. Not all electronic or electrical components, as the case may be, have to be cooled by the exhaust air; only one or more electronic or electrical components, as the case may be, can be cooled with exhaust air.

In an advantageous additional embodiment, the lower part is formed of two horizontally separated pieces, wherein it is preferentially provided that one piece is arranged between the base of the housing and the safety container and the other piece are arranged between the safety container and the centrifuge container. This improves the mountability in the case of a safety container.

In an advantageous additional embodiment, the air directing means are adapted to guide the supply air into the centrifuge container in the direction of rotation of the centrifuge rotor and/or to introduce the supply air into the centrifuge container close to the axis of rotation. Due to the guidance in the direction of rotation, the air guide is particularly efficient. The supply air close to the axis causes an impeller effect through the centrifuge rotor, which increases the air flow.

In an advantageous additional embodiment, the air directing means are adapted to collect and guide the exhaust air collected past the centrifuge motor and/or electronic components. This results in particularly effective cooling of the other centrifuge components.

In an advantageous additional embodiment, the air directing means are adapted to extract the air moved in the centrifuge container by the centrifuge rotor at the rim of the centrifuge container. This supports the impeller effect.

In an advantageous additional embodiment, the air directing means have a rough surface at least in some regions. As a result, local turbulence occurs, which leads to an overall reduction in flow resistance.

In an advantageous additional embodiment, the air directing means have at least one selectively closable air guide. This can support the start-up of the centrifuge rotor when the centrifuge is started or the deceleration of the centrifuge rotor when the centrifuge is stopped, as the case may be, by reducing or completely eliminating, as the case may be, the supply air when the centrifuge is started and increasing the supply air when the centrifuge is stopped. The closure can be provided, for example, by a flap that can be closed and opened.

In an advantageous additional embodiment, the air directing means at least partially enclose the centrifuge motor horizontally. Preferentially, there is complete enclosure by the air directing means horizontally between the housing base and the safety container or centrifuge container, except for at least one exhaust air inlet and at least one exhaust air outlet. A particularly defined air flow and thus cooling effect then takes place at the centrifuge motor.

In an advantageous additional form, the air directing means are configured to perform at least one of the following functions:
Suction in of the supply air through one or more supply air openings, which are arranged at the base and/or near the base on at least one side wall of the centrifuge housing,
Guiding of the supply air into the interior of the centrifuge container without coming into contact with heat-emitting elements of the centrifuge, in particular the centrifuge motor and/or electronic components of the centrifuge, wherein the supply air is preferentially introduced into the centrifuge container close to the axis of rotation of the centrifuge rotor,
Removal of the exhaust air from the centrifuge container, wherein the exhaust air is preferentially removed from the centrifuge container far from the axis of rotation of the centrifuge rotor,
Guiding of the exhaust air behind the outer wall of the centrifuge container in the direction of the base of the centrifuge housing, wherein the exhaust air is preferentially guided between the centrifuge container and the safety container,
Guiding of the exhaust air to the centrifuge motor and/or electronic components of the centrifuge, wherein the exhaust air is preferentially first guided to the centrifuge motor for its cooling and then to the electronic components of the centrifuge for their cooling,
Discharge of the exhaust air out of the centrifuge housing into the surrounding area of the centrifuge. This air guide is suitable for the particularly effective cooling of the centrifuge container and the centrifuge.

The method for controlling the temperature of a centrifuge rotor of a centrifuge, in particular a laboratory centrifuge, having a centrifuge container in which a centrifuge rotor can be accommodated, a centrifuge motor for driving the centrifuge rotor, a housing having a base and lateral side walls, wherein the centrifuge container, the centrifuge rotor and the centrifuge motor, and a temperature control device for controlling the temperature of the centrifuge rotor, are accommodated in the housing, is characterized in that air directing means are used, which are adapted to suck in (in particular by the rotation of the centrifuge rotor) air into the centrifuge container in a lower region.

In an advantageous additional embodiment, the centrifuge in accordance with the disclosure is used.

In an advantageous additional embodiment, the air directing means of the centrifuge in accordance with the disclosure are used.

In an advantageous additional embodiment, air is introduced into the centrifuge container close to the axis and removed from the centrifuge container far from the axis. In principle, this allows centrifugal forces and, with the help of the centrifuge rotor, a bucket-wheel effect to be harnessed to support the air flow.

In an advantageous additional embodiment, the supply air is at least partially throttled, preferentially blocked, when the centrifuge is started. As a result, the centrifuge is started without consuming a great amount of energy, because the air friction resistance of the centrifuge rotor is reduced.

In an advantageous additional embodiment, when the centrifuge is stopped, the supply air to the centrifuge container is increased. The stopping of the centrifuge rotor is then accelerated by air friction resistance.

In an advantageous additional embodiment, the temperature of the centrifuge rotor or the samples accommodated therein, as the case may be, is adjusted by controlling the air flow through the centrifuge container. This results in particularly simple temperature control.

For the three aforementioned additional embodiments, an air control system can be provided, which controls the air volume in response to a start or stop command, as the case may be, and/or to the rotational speed of the centrifuge rotor.

The features and further advantages of the present invention will become apparent below from the description of a preferential exemplary embodiment in connection with the figures.

### BRIEF DESCRIPTION OF THE DRAWINGS

FIG. 1 shows a centrifuge in a perspective view.

FIG. 2 is a vertical sectional view of the centrifuge according to FIG. 1.

FIG. 3 shows the centrifuge according to FIG. 1 in a first horizontal sectional view x-x.

FIG. 4 shows the centrifuge according to FIG. 1 in a second horizontal sectional view y-y.

FIG. 5 shows the one piece of the lower part of the air directing means of the centrifuge according to FIG. 1 in a perspective view from above.

FIG. 6 shows the one piece according to FIG. 5 in a perspective view from below.

FIG. 7 shows the other piece of the lower part of the air directing means of the centrifuge according to FIG. 1 in a perspective view from above.

FIG. 8 shows the other piece according to FIG. 7 in a perspective view from below.

FIG. 9 shows the upper part of the air directing means of the centrifuge according to FIG. 1 in a perspective view from above.

FIG. 10 shows the upper part according to FIG. 9 in a perspective view from below.

FIG. 11 shows a view into the safety container of the centrifuge according to FIG. 1 in a perspective view from above in a partial illustration.

FIG. 12 is a view of the centrifuge container of the centrifuge according to FIG. 1 in a perspective view from above in a partial illustration.

### DETAILED DESCRIPTION

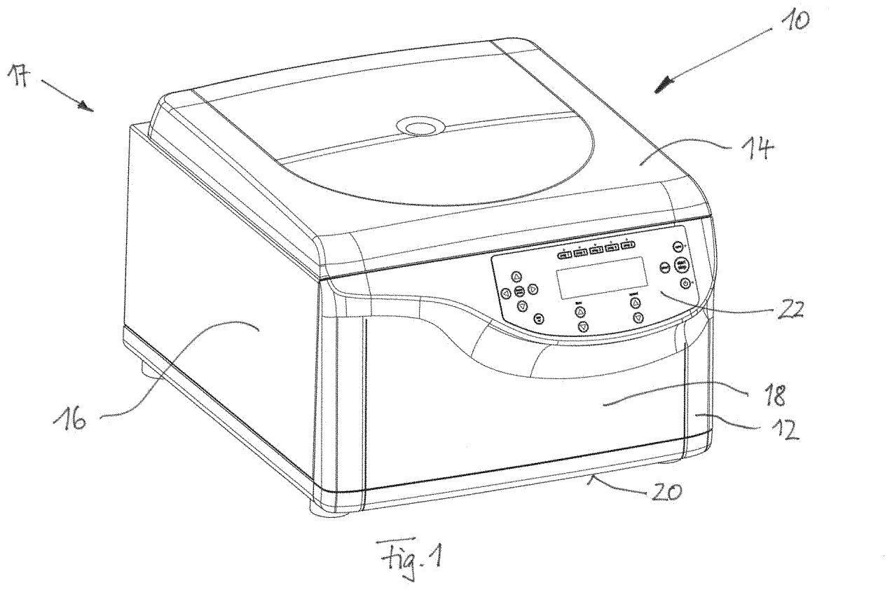

FIGS. 1 to 12 show the centrifuge 10, along with its most important components, in numerous views.

The centrifuge is a laboratory centrifuge 10, which in accordance with FIG. 1 has a centrifuge housing 12 with a centrifuge lid 14, side walls 16, a rear wall 17, a front 18 and a base 20. A control unit 22 is integrated into the front 18 in the usual manner. The side walls 16 and also the rear wall 17 have ventilation openings (not shown), in the form of slots, through which air can pass into and out of the centrifuge housing 12.

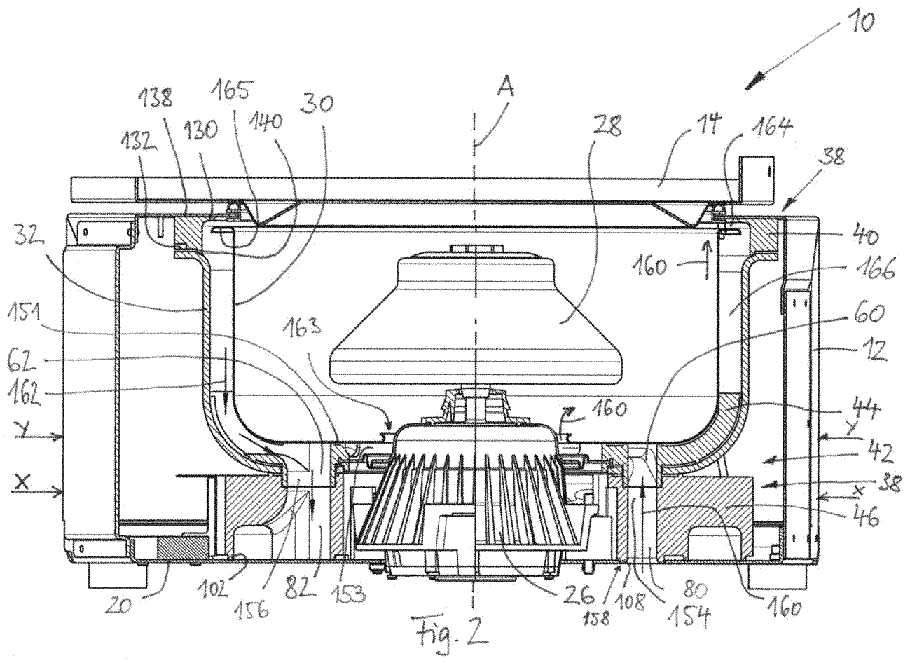

FIGS. 2 to 4 show that the laboratory centrifuge 10 has a centrifuge motor 26, which, when correspondingly controlled, drives a removable centrifuge rotor 28. Sample receptacles for sample vessels (both not shown) are arranged in the centrifuge rotor 28 in the usual manner. Samples accommodated in the sample vessels can then be centrifuged.

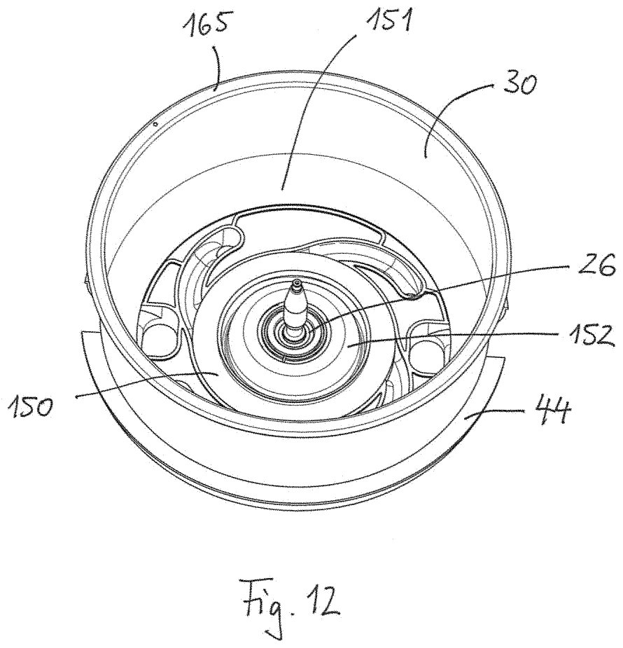

The centrifuge rotor 28 runs in a centrifuge container 30 made of stainless steel, which is surrounded by a safety container 32 that prevents rotor components from escaping outside the centrifuge housing 12 in the event of a crash. This safety container 32 is designed to be suitably reinforced. The centrifuge container 30 is shown in more detail in FIG. 11 and the safety container 32 is shown in more detail in FIG. 12.

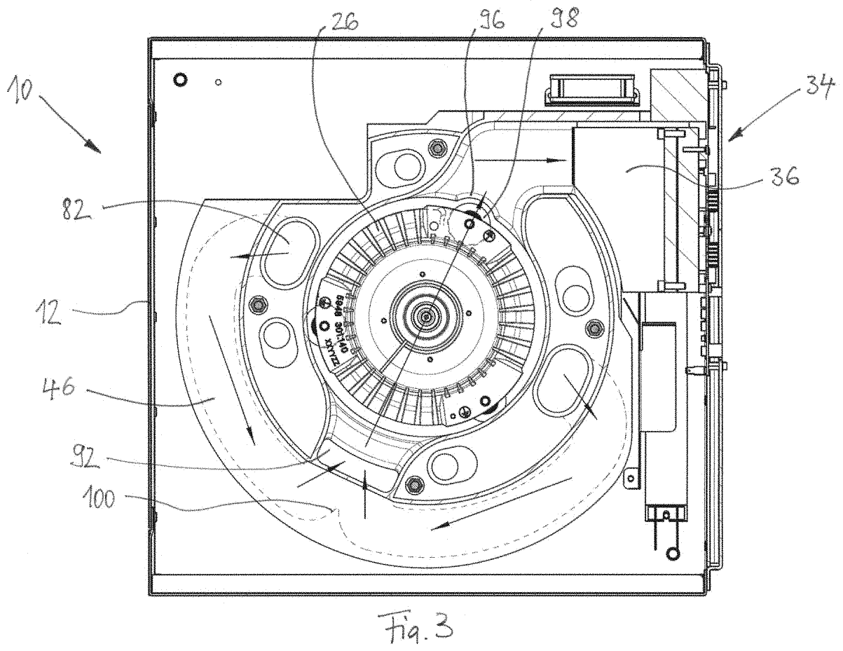

The laboratory centrifuge 10 has electronic components 34 for operating and controlling and regulating the laboratory centrifuge 10, as is particularly apparent from FIG. 3. For improved heat dissipation, a cooling fin element 36 is provided, the cooling fins (not shown) of which extend horizontally.

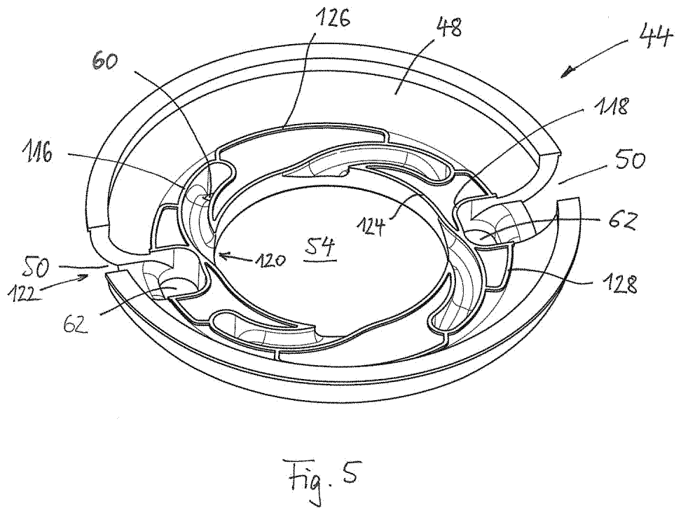

In addition, air directing means 38 are arranged in the laboratory centrifuge 10, which are shown in more detail in FIGS. 5 to 10. Such air directing means 38 are formed by an upper part 40 and a lower part 42, wherein the lower part 42 is in turn subdivided into a piece 44 and another piece 46.

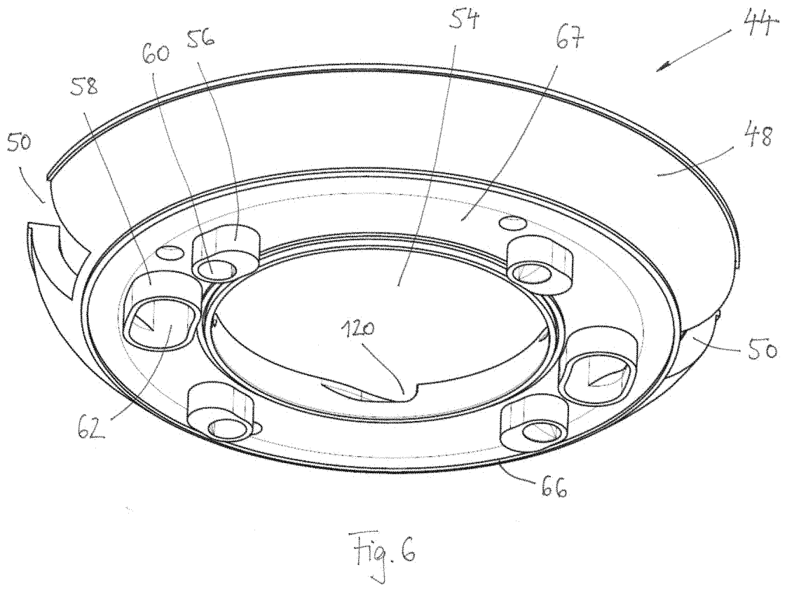

According to FIGS. 5 and 6, one piece 44 of the lower part 42 of the air directing means 38 has a roughly bowl-shaped configuration, which opens upward with a raised rim 48. Two laterally opposed recesses 50 are provided in the rim 48.

A central aperture 54 is designed to encompass the centrifuge motor 26 and is located in the center of one piece 44.

Further, the one piece 44 has four first connecting pieces 56 and two second connecting pieces 58. Each of the connecting pieces has feedthroughs 60, 62 through the one piece 44. The feedthroughs 62 through the second connecting pieces 58 thereby correspond to the respective recess 50. Circumferential projections 64, 66 in the form of fins, which define between them a first connecting region 67, are located inside and outside with respect to the connecting pieces 56, 58.

FIG. 3 and FIG. 5 show that the feedthroughs 60 extend parallel to the direction of rotation D of the centrifuge rotor 28 in a spiral shape in the direction of the axis of rotation A.

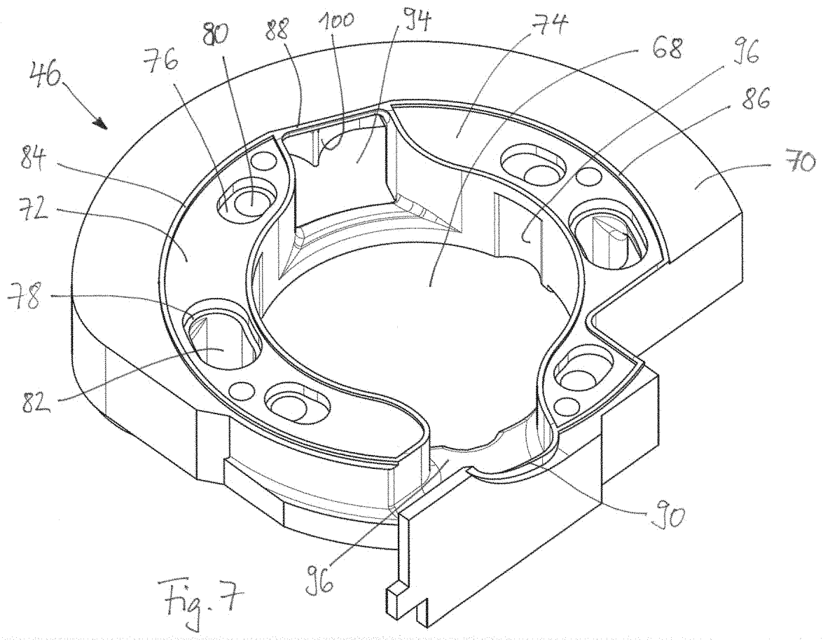

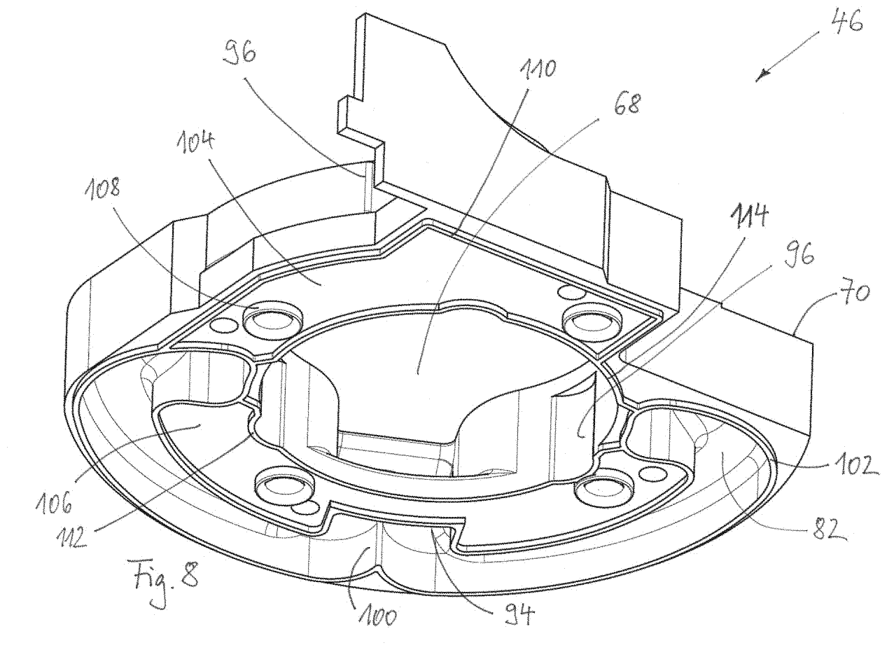

According to FIGS. 7 and 8, the other piece 46 of the lower part 42 of the air directing means 38 has a generally tire-shaped configuration with a central recess 68, which is designed for the spaced horizontal enclosure of the centrifuge motor 26.

The other piece 46 has a partial circumferential rim 70 and interior second connecting regions 72, 74, which have four first depressions 76 and two second depressions 78 with corresponding feedthroughs 80, 82 corresponding to the connecting pieces 56, 58. Such second connecting regions 72, 74 are in turn surrounded by circumferential projections 84, 86 in the form of fins, wherein, further, a connecting projection 88 in the form of a fin is arranged between the circumferential projections 84, 86 and a joining projection 90 is arranged in the form of a fin on the projection 86.

The central recess 68 corresponds with an exhaust air inlet 92 and an exhaust air outlet 94 and has three fillets 96, which are designed for the spaced enclosure of corresponding fastening elements 98 of the centrifuge motor 26 in the housing base 20 (see FIG. 3).

A curved wedge 100 is located in the exhaust air inlet 92, which brings together the two feedthroughs 82 of the two second depressions 78 and directs them in the direction of the central recess 68 and the exhaust air outlet 96. The feedthroughs 82, are exactly opposite each other in the second depressions 78 with respect to the axis of rotation A of the centrifuge rotor 28, thus each describe a 90° curve under the second connecting region 72, 74 and the rim 70. As shown in FIG. 3, coming from the depressions 78 they first pass radially outward into the rim 70 and then circulate in such rim 70 until they reach the wedge 100 and the exhaust air inlet 92.

The two feedthroughs 82 are surrounded by a common projection 102 in the form of a fin. The four feedthroughs 80 open into two oppositely arranged third connecting regions 104, 106 with corresponding supply air ports 108, which are also embodied as projections. The connecting regions 104, 106 are in turn surrounded by circumferential projections 110, 112. Thereby, the circumferential projections 110, 112 and 102 are embodied to be partially overlapping. There is also a connecting projection 114.

According to FIG. 5, the one piece 44 of the lower part 42 of the air directing means 38 also has connecting projections 116, 118 in the form of fins, which surround the feedthroughs 60, 62 in some regions, wherein ports 120, 122 are recessed in each case. In addition, connecting projections 124, 126, 128 are provided in the form of fins.

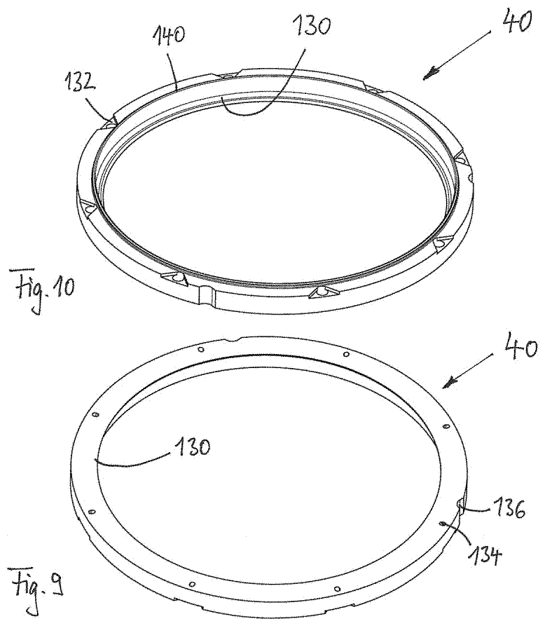

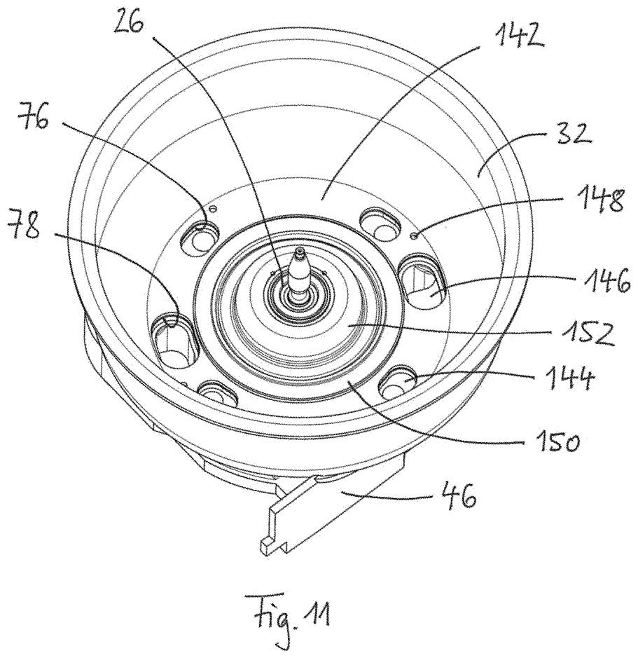

FIGS. 9 and 10 show that the upper part 40 of the air directing means 38 is embodied to be hoop-like, wherein the hoop has an internal circumferential collar 130. Additionally, moldings 132, 134, 136 exist to secure and align the upper part 40 with respect to the safety container 32 and the upper part 138 of the housing 12. The axial projection 140, which is embodied as a continuous fin, is used to seal against the safety container 32.

FIG. 11 shows that the safety container 32 has apertures 144, 146 in its base 142 for connection to the feedthroughs 80, 82 of the other piece 46 of the lower part 42 of the air directing means 38, boreholes 148 for attaching the safety container 32 to the base 20 of the housing 12 and a central opening 150 for accommodating the centrifuge motor 26.

Due to the circumferential projections 84, 86 along with the connecting projection 88 and the joining projection 90, the second connecting regions 72, 74 do not directly abut the safety container 32; rather, a tolerance compensation is effected, by which the accuracy of fit is improved when connecting the safety container 32 and the other piece 46 of the lower part 42, since the projections 84, 86, 88, 90 can be pressed very easily.

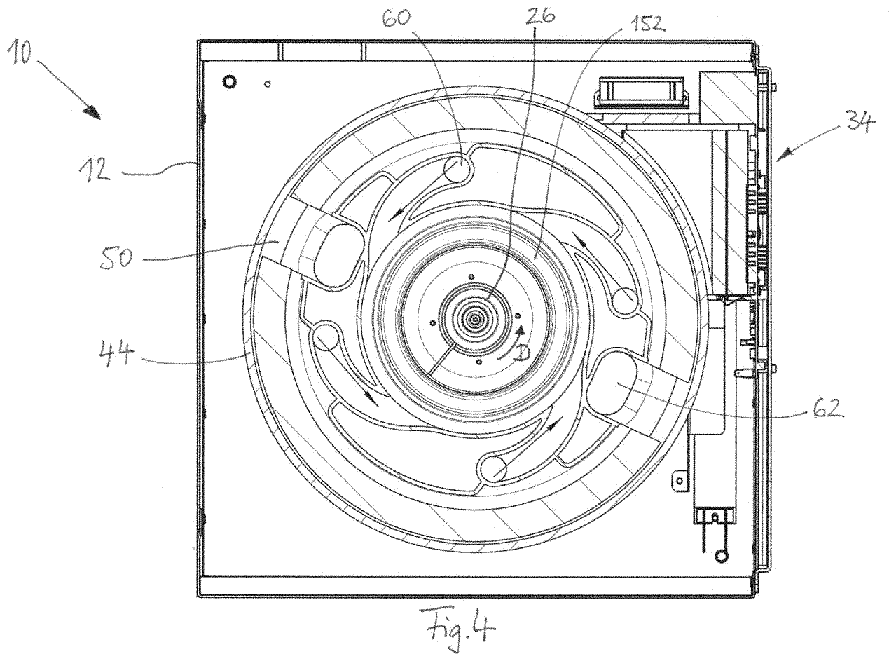

Finally, FIG. 12 shows that the centrifuge container 30, which is inserted in the one piece 44 of the lower part 42, has a base 151, which is only partially shown in FIG. 12 (and, in fact, with an annular recess, which is actually not present, in order to illustrate the air directing paths) (see FIG. 2). Below the base 151 is a sleeve 152 around the centrifuge motor 26 (see FIGS. 2 and 4), which is fixed in the one piece 44 with its outer circumference (see FIG. 2), thereby acting as a seal and forming, together with the base 151 of the centrifuge container 30, an air directing space 153, which communicates with the four ports 120.

Here as well, a very good fit and at the same time a sealing of the feedthroughs 60 and the ports 120 results from the projections 116, 118, 126, 128, which are pressable (compressible) and compensate for tolerances.

In the assembled state according to FIG. 2, the centrifuge container 30 with the one piece 44 of the lower part 42 is inserted in the safety container 32 according to FIG. 11.

The apertures 144, 146 of the safety container 32 align in cross-section with the respective cross-sections of the depressions 76, 78, such that the connecting pieces 56, 58 can fit snugly into the depressions 76, 78, in order to thereby connect the feedthroughs 60, 62 to the feedthroughs 80, 82 in a sealed manner. As a result, no supply or exhaust air can escape in the connecting region between the other piece 46, the safety container 32 and a piece 44; rather, it is directed entirely through the formed air directing channels 154, 156.

Due to the fact that the other piece 46 of the lower part 42 has projections 102, 110, 112, 114, the other piece 46 again does not lie fully against the base 20 of the housing, thus ensuring tolerance compensation.

The supply air ports 108, in the assembled stated corresponding to FIG. 2, engage directly with corresponding apertures 158 in the base 20 of the housing 12, resulting in an overall closed air guide 160, 162 of supply air 160 and exhaust air 162.

More specifically, the supply air 160 is sucked in through the four apertures 158 located in the base 20 and transferred to the supply air ports 108 and the feedthroughs 80. From there, the supply air is transferred to the connecting pieces 56 and transported through the feedthroughs 60 via the ports 120 to the air directing space 153 formed by the sleeve 152 and the base 151 of the centrifuge container 30, and from there through the inlet opening 163 embodied as an annular gap 163 between the centrifuge container 30 and the sleeve 152 of the centrifuge motor 26, close to the axis, into the centrifuge container 30.

The rotation of the centrifuge rotor 28 in the direction of rotation results in an impeller effect, causing the exhaust air to be thrown outward against the centrifuge container 30, thereby accelerating it. As a result, the sucking in of the supply air 160 takes place automatically, wherein such effect is further supported by the fact that, as shown in FIG. 4, the feedthroughs 60 run spirally inwards in the direction of rotation.

The supply air 160 enters the annular gap 164 located between the centrifuge container 30 and the upper part 138 of the housing 12 (the annular gap 164 is bounded by the upper flange 165 of the centrifuge container 30 and the upper part 138 of the housing 12) and is directed through the upper part 40 with the collar 130 into the intermediate space 166 between the centrifuge container 30 and the safety container 32, which extends around the centrifuge container 30. The exhaust air 162 is directed through the two gaps 50 and the ports 122 to the feedthroughs 62, and from there into the feedthroughs 82. From the feedthroughs 82, the exhaust air 162 continues into the exhaust air channels 156 until it meets the wedge 100 and from there is directed past the centrifuge motor 26 in the direction of the cooling fin element 36 and the electronic components 34.

The flow directions of supply air 160 and exhaust air 162 are each indicated by arrows.

It can be seen that the supply air is introduced directly from the cold base region into the centrifuge container 30, bypassing warm regions of the centrifuge 10. This is done without any assistance from blowers and the like, because the rotation of the centrifuge rotor 28 produces an impeller effect, drawing the supply air 160 into the centrifuge container 30. This results in particularly effective cooling of the centrifuge rotor 28 with the samples contained therein along with the centrifuge container 30.

Subsequently, the supply air 160 flows over the annular gap 164 and is guided in contact with the centrifuge container 26 in the intermediate space 166 between the centrifuge container 26 and the safety container 32, resulting in further cooling of the centrifuge container 26 and thus the centrifuge rotor 28 with the samples contained therein.

Finally, once the centrifuge container 30 has been cooled, the exhaust air 162 is still used to cool the centrifuge motor 26 along with the electronic components 34 and their cooling device 36, thereby reducing the heat input of such elements 26, 34, 36 into the centrifuge container 30 from the outset, which ultimately also results in the cooling of the centrifuge container 30 along with the centrifuge rotor 28 with the samples contained therein.

It is also clear from the foregoing illustration that a centrifuge 10 is provided with a temperature control that operates more effectively than previously used temperature-controlled centrifuges. At the same time, such temperature control can also be used to cool heat-emitting centrifuge components, such as centrifuge motor 26 and electronic components 34, 36. In addition, such temperature control also functions if a safety container 32 is arranged around the centrifuge container 30.

Unless otherwise indicated, all features of the present disclosure may be freely combined with each other in isolation from other features. Also, unless otherwise indicated, the features described in the figure description can be freely combined as features in isolation with the other features. In doing so, features of the device can also be reformulated as method features and method features can be reformulated as device features.

### LIST OF REFERENCE SIGNS

10 Centrifuge, laboratory centrifuge
12 Centrifuge housing
14 Centrifuge lid
16 Side walls
17 Back wall
18 Front
20 Base
22 Control unit
26 Centrifuge motor
28 Centrifuge rotor
30 Centrifuge container
32 Safety container
34 Electronic components of the centrifuge 10
36 Cooling fin element
38 Air directing means
40 Upper part of the air directing means 38
42 Lower part of the air directing means 38
44 A piece of the lower part 42 of the air directing means 38
46 Other piece of the lower part 42 of the air directing means 38
48 Raised rim of the one piece 44
50 Two recesses arranged laterally opposite each other in the rim 48
54 Central aperture of the one piece 44
56 Four first connecting pieces
58 Two second connecting pieces
60 Feedthroughs of the four first connecting pieces 56
62 Feedthroughs of the two second connecting pieces 58
64, 66 Circumferential projections, fins
67 First connecting region
68 Central recess of the other piece 46
70 Partial circumferential rim 70 of the other piece 46
72, 74 Second connecting regions
76 Four first depressions
78 Two second depressions
80 Feedthroughs of the four first depressions 76
82 Feedthroughs of the two second depressions 78
84, 86 Circumferential projections, fins
88 Connecting projection, fin
90 Joining projection, fin
92 Exhaust air inlet
94 Exhaust air outlet
96 Three fillets
98 Fastening elements of the centrifuge motor 26 in the housing base 20
100 Curved wedge
102 Common projection of the two feedthroughs 82, fin
104, 106 Oppositely arranged third connecting regions
108 Supply air ports, projections, fins
110, 112 Circumferential projections, fins
114 Connecting projection, fin
116, 118 Connecting projections, fins
120, 122 Ports
124, 126, 128 Connecting projections, fins
130 Inner circumferential collar of the upper part 40 of the air directing means 38
132, 134, 136 Moldings
138 Upper part of the housing 12
140 Axial projection, fin
142 Base of the safety container 32
144, 146 Apertures in the base 142
148 Boreholes in the base 142
150 Central opening in the base 142
151 Base of the centrifuge container 30
152 Sleeve of the centrifuge motor 26
153 Air directing space
154, 156 Air directing channels
158 Apertures in the base 20 of the housing 12
160 Supply air
162 Exhaust air
163 Annular gap between the centrifuge container 30 and the sleeve 152 of the centrifuge motor 26, inlet opening for supply air 160 into the centrifuge container 30
164 Annular gap between the centrifuge container 30 and the upper part 138 of the housing 12
165 Upper flange of the centrifuge container 30
166 Intermediate space between the centrifuge container 30 and the safety container 32
D Direction of rotation of the centrifuge rotor 28
A Axis of rotation

1.-15. (canceled)

16. A centrifuge (10), comprising:
a centrifuge container (30) in which a centrifuge rotor (28) is accommodated;
a centrifuge motor (26) for driving the centrifuge rotor (28);
a housing (12) with a base (20) and lateral side walls (16, 17, 18), the centrifuge container (30), the centrifuge rotor (28) and the centrifuge motor (26) being accommodated in the housing; and
a temperature control device for controlling the temperature of the centrifuge rotor (28),
wherein the temperature control device comprises air directing means (38), which are adapted to suck in supply air (160) into the centrifuge container (30) in a lower region (151, 152).

17. The centrifuge (10) according to claim 16,
wherein the air directing means (38) are configured to suck in supply air (160) through the base (20) and/or at least one side wall of the centrifuge housing (12),
wherein the supply air (160) is directed directly from the centrifuge housing (12) to the centrifuge container (30), without coming into contact with heat-emitting elements of the centrifuge, in particular the centrifuge motor (26) and/or electronic components (34, 36) of the centrifuge (10).

18. The centrifuge (10) according to claim 16,
wherein the air directing means (38) are configured to discharge exhaust air (162) from the centrifuge container (30) out of the centrifuge housing (12) in such a way that re-entry of the exhaust air (162) into the centrifuge container (30) is prevented.

19. The centrifuge (10) according to claim 16,
wherein the air directing means (38) are configured
to guide exhaust air (162) from the centrifuge container (30) past the centrifuge motor (26) and/or past electronic components (34, 36) of the centrifuge (10), wherein the exhaust air (162) is guided first past the centrifuge motor (26) and then past electronic components (34, 36), and/or
to guide exhaust air (162) from the centrifuge container (30) along an outer side of the centrifuge container (30, 164).

20. The centrifuge (10) according to claim 19, further comprising
a safety container (32) at least partially enclosing the centrifuge container (30),
wherein the air directing means (38) are configured to guide exhaust air (162) from the centrifuge container (30) between (166) the centrifuge container (30) and the safety container (32), and
wherein the safety container (32) comprises one or more openings (144) for the supply air (160) in its base region (142).

21. The centrifuge (10) according to claim 16, wherein
the air directing means (38) are embodied to be thermally insulated at least in some regions and/or that the centrifuge container (10) is provided with thermal insulation (44) on its outer side in the region of the air directing means (38) and/or
the air directing means (38) are embodied as one or more foam molded parts (40, 44, 46) made of polypropylene or polyurethane, and/or at least one sound-insulating foam element (40, 44, 46) made of polyurethane is used for sound insulation.

22. The centrifuge (10) according to claim 20,
wherein the air directing means (38) are embodied in several parts, consisting of
a lower part (42) for supplying the supply air (160) to the centrifuge container (30) and for discharging the exhaust air (162) to the centrifuge motor (26) and/or to electronic components (34, 36), and
an upper part (40) for discharging the exhaust air (162) from the centrifuge container (30) into a space (166) between the centrifuge container (30) and the safety container (32).

23. The centrifuge (10) according to claim 22,
wherein the lower part (42) is formed of two horizontally separated pieces (44, 46), wherein
one piece (46) of the two horizontally separated pieces is arranged between the base (20) of the housing (12) and the safety container (32) and
another piece (44) of the two horizontally separated pieces is arranged between the safety container (32) and the centrifuge container (30).

24. The centrifuge (20) according to claim 16,
wherein the air directing means (38) are adapted to guide the supply air (160) into the centrifuge container (30) in a direction of rotation (D) of the centrifuge rotor (28) and/or to introduce the supply air (160) into the centrifuge container (30) close to an axis of rotation (A), and/or
wherein the air directing means (38) are adapted to extract the air moved in the centrifuge container (30) by the centrifuge rotor (28) at a rim (164) of the centrifuge container (30).

25. The centrifuge (10) according to claim 16,
wherein the air directing means have a rough surface at least in some regions and/or
wherein the air directing means have at least one selectively closable air guide.

26. The centrifuge (10) according to claim 20,
wherein the air directing means (38) completely enclose the centrifuge motor (26) horizontally between the base (20) and the safety container (32) or centrifuge container (30), except for at least one exhaust air inlet (50) and at least one exhaust air outlet (62).

27. The centrifuge (10) according to claim 20,
wherein the air directing means (38) are configured to perform at least one of the following functions:
sucking in the supply air (160) through one or more supply air openings (158), which are arranged on the base (20) and/or near the base on at least one side wall of the centrifuge housing (12),
guiding the supply air (160) into an interior of the centrifuge container (30) without coming into contact with heat-emitting elements of the centrifuge, in particular the centrifuge motor (26) and/or electronic components (34) of the centrifuge, wherein the supply air (160) is introduced into the centrifuge container (30) close to an axis of rotation (A) of the centrifuge rotor (289),
removing the exhaust air (162) from the centrifuge container (30), wherein the exhaust air (162) is removed from the centrifuge container (30) far from the axis of rotation (A) of the centrifuge rotor (28),
guiding of the exhaust air (162) behind an outer wall of the centrifuge container (30) in the direction of the base (20) of the centrifuge housing (12), wherein the exhaust air (162) is guided between the centrifuge container (30) and the safety container (32),
guiding the exhaust air to the centrifuge motor (26) and to electrical components of the centrifuge, wherein the exhaust air is first guided to the centrifuge motor for its cooling and then to the electrical components of the centrifuge for their cooling,
discharging the exhaust air out of the centrifuge housing into a surrounding area of the centrifuge.

28. A method for controlling the temperature of a centrifuge rotor (28) of a centrifuge (10), the centrifuge comprising
a centrifuge container (30) in which a centrifuge rotor (28) is accommodated,
a centrifuge motor (26) for driving the centrifuge rotor (28),
a housing (12) having a base (20) and lateral side walls (16, 17, 18), wherein the centrifuge container (30), the centrifuge rotor (28) and the centrifuge motor (26), are accommodated in the housing, and
a temperature control device for controlling the temperature of the centrifuge rotor (28), (12),
wherein the method is characterized in that air directing means (38) are used to suck supply air (160) into the centrifuge container (30) in a lower region (151, 152).

29. The method according to claim 28,
air (160) is introduced into the centrifuge container (30) close to an axis (A) and is removed from the centrifuge container (30) far (164) from the axis.

30. The method according to claim 28,
wherein, when the centrifuge is started, the supply air is at least partially throttled, and/or wherein, when the centrifuge is stopped, the supply air to the centrifuge container is increased and/or
wherein the temperature of the centrifuge rotor is adjusted by controlling an air flow through the centrifuge container.
